(19) United States
(12) Patent Application Publication
(10) Pub. No.: US 2022/0335467 A1
(43) Pub. Date: Oct. 20, 2022

(54) LOCATION-BASED LOYALTY SERVICE

(71) Applicant: NCR Corporation, Atlanta, GA (US)

(72) Inventors: Aleah Jean Kadry, Atlanta, GA (US); Gina Torcivia Bennett, Lawrenceville, GA (US); Kip Oliver Morgan, Atlanta, GA (US); Jacob Alexander Poston, Loganville, GA (US)

(21) Appl. No.: 17/301,766

(22) Filed: Apr. 14, 2021

(51) Int. Cl. G06Q 30/02; G06Q 20/32; G06Q 20/18; G06Q 20/20

(52) U.S. Cl. CPC G06Q 30/0226; G06Q 20/3224; G06Q 20/3276; G06Q 20/18; G06Q 20/202; G06Q 30/0238; G06Q 20/321; G06F 16/245

(57) ABSTRACT

Location information for a user-operated device is obtained or location information associated with a transaction terminal is obtained. A store associated with the location is resolved based on the location information. Loyalty identifiers for a user who operates the device are identified. The loyalty identifiers are used to obtain a loyalty account of the user with the store and the location information is used to identify a transaction that the user is engaged in at the store. A loyalty account number for the loyalty account is dynamically injected into a transaction workflow for the transaction without requiring entry of the loyalty identifiers or the loyalty account number by the user or a cashier who may be performing the transaction on behalf of the user.

### BACKGROUND

COVID19 has dramatically changed behaviors of consumers and retailers. Consumers and retailers are now vastly more aware of health safety, which is designed to mitigate the spread of the virus. For example, consumers have been encouraged to stay at home, and when they are unable to stay at home, wear facial coverings and keep at safe physical distances from others while in public in order to prevent virus transmission. Retailers have reduced customer capacity, put physical barriers between customers while dining, labeled floors with markers to inform customers in line what a safe distance is considered to be, etc.

Retailers have implemented technology and changed business procedures to reduce contact between staff and their customers. For example, plexiglass now separates cashiers from customers during checkouts and Self-Checkouts (SCOs) permit touchless payment options to customers which can be completed on the customers' mobile phones.

However, little to no COVID19-friendly technology or procedures have been provided to mitigate customer interactions with the retailer and with SCOs when a customer desires to use their retailer-registered loyalty account during checkouts. Many retailers offer reduced prices for loyalty-registered customers and other loyalty-based customer incentives in exchange for capturing valuable metrics and information about the purchases of their customers. It is a mutually beneficial arrangement that provides reduced prices to loyalty customers and that provides indispensable marketing information to the retailers.

Customer usage of their loyalty accounts typically requires the customer to swipe a card, enter or provide a registered phone number, enter or provide a loyalty account number, or enter or provide a registered email address.

SCO-based interactions require the customer to manually touch the touch display to enter loyalty identifiers or require the customer to find their loyalty card and swipe or scan it at the SCOs. All of which, creates a virus exposure risk to the customer when touching the display of the SCO to provide the loyalty identifier or by remaining at the SCO for longer than was necessary to locate and provide their loyalty card.

Cashier-assisted checkouts require the customers to verbally recite their loyalty identifiers to the cashiers for entry by the cashiers or require the customers to provide their loyalty cards to the cashiers for swiping or scanning by the cashiers. Exchanging a card with the cashier creates a virus exposure risk for both the customer and the cashier. Furthermore, many customers are uncomfortable with publicly saying personal information (e.g., loyalty identifiers for account numbers, phone numbers, or email addresses), which can be heard by other customers waiting in line behind the customer. Some customers are even uncomfortable with divulging the private information associated with the loyalty identifiers to the cashiers.

Moreover, customers are inundated with loyalty cards from many different retailers so much so that they refuse to carry all the cards in their wallets or purses. Even when customers do have the cards, it is inconvenient for them to search for the cards during the checkout and it causes frustration to other customers queued behind them for checkouts.

In fact, some customers refuse to open loyalty accounts even when they know it would save them money because they simply do not want to hassle with managing yet-another loyalty card and loyalty account. Also, infrequently used loyalty accounts are typically completely forgotten by the customer during checkouts. Lack of customer loyalty account use or customer adoption has tangible negative effects on the marketing information relied upon by the retailers.

### SUMMARY

In various embodiments, methods and a system for location-based loyalty services are presented.

According to an embodiment, a method for location-based loyalty service is provided. For example, location information that is associated with a user is obtained. Loyalty information for the user which is associated with an establishment location is obtained. The establishment location corresponds or correlates with the location information. A transaction that the user is engaged in at the establishment location is identified. A loyalty account number associated with the loyalty information is dynamically injected into a transaction workflow for the transaction.

### BRIEF DESCRIPTION OF THE DRAWINGS

FIG. 1A is a diagram of a system for providing location-based loyalty services, according to an example embodiment.

FIG. 1B is a diagram for identifying a store that a consumer is present within using location-based services, according to an example embodiment.

FIG. 1C is a diagram depicting an identification of a loyalty account of the consumer, according to an example embodiment.

FIG. 1D is a diagram depicting an identification of a specific transaction being performed by or on behalf of the consumer where the loyalty account of the consumer is injected into the transaction workflow, according to an example embodiment.

FIG. 1E is a diagram depicting an identification of a specific transaction terminal of an in-progress transaction being performed by or on behalf of the consumer with the loyalty account of the user injected into the in-progress transaction workflow at the terminal, according to an example embodiment.

FIG. 1F is a diagram depicting integration of the consumer's loyalty account into the transaction workflow of the transaction terminal in order to dynamically modify transaction prices for items based on the consumer's loyalty account, according to an example embodiment.

FIG. 2 is a diagram of a method for providing location-based loyalty services, according to an example embodiment.

FIG. 3 is a diagram of another method for providing location-based loyalty services, according to an example embodiment.

### DETAILED DESCRIPTION

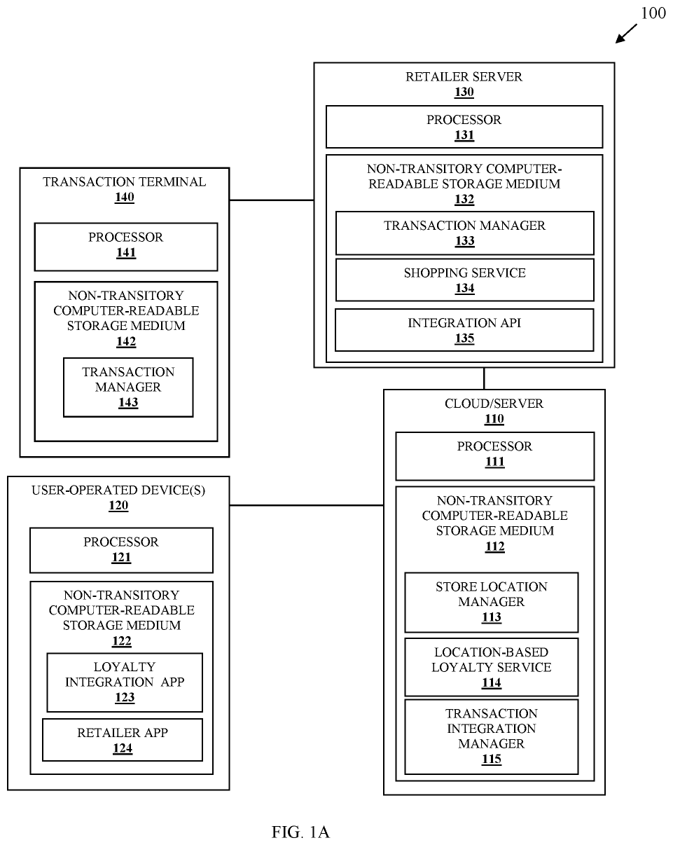

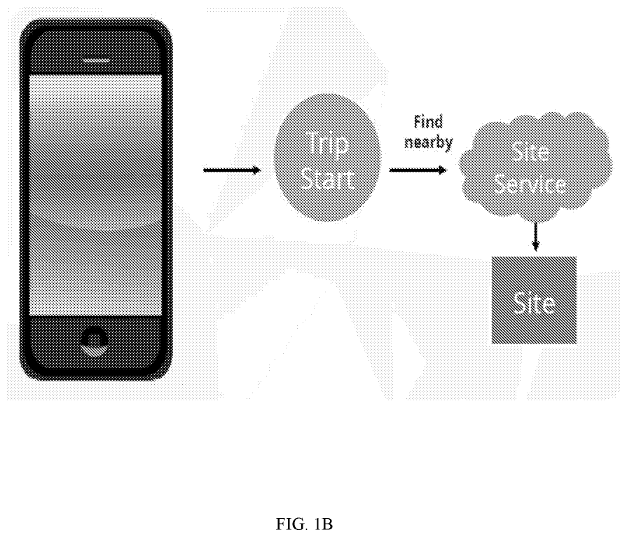

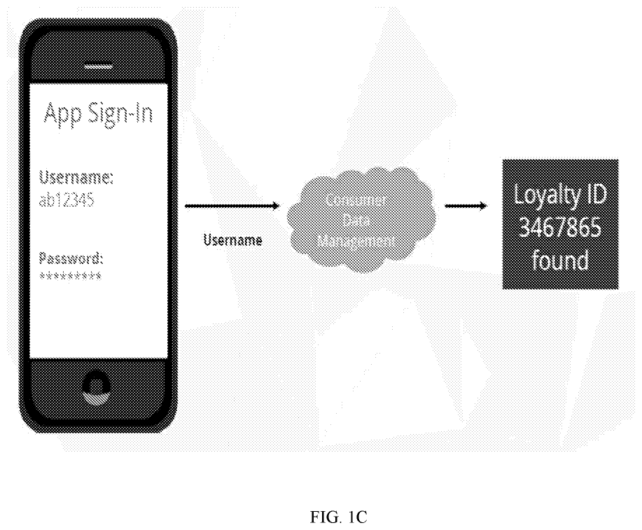

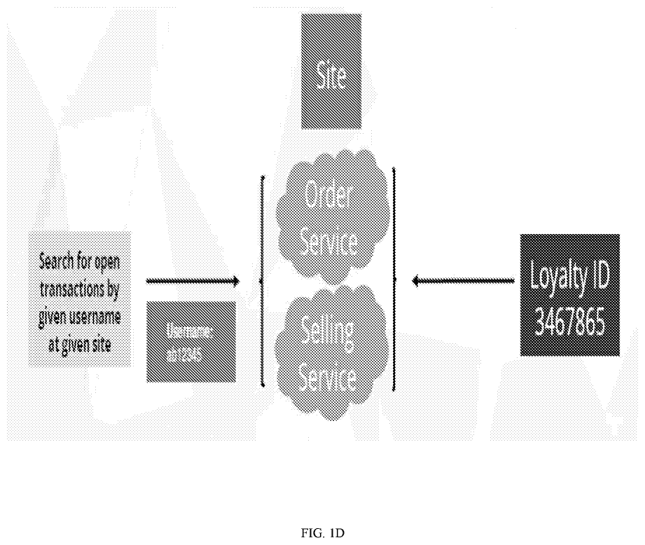

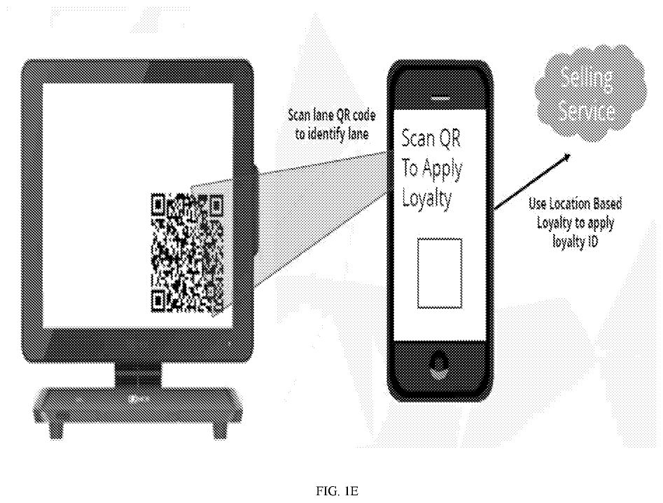

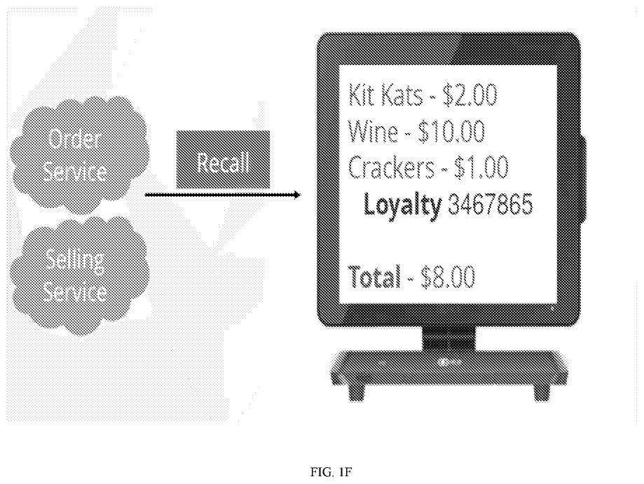

FIG. 1A is a diagram of a system 100 for providing location-based loyalty services, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of providing location-based loyalty services, presented herein and below.

As will be discussed herein and below, methods and a system 100 are provided for location-based loyalty services. A mobile application of a user provides location information for the user's mobile device. The user is registered with a location-based loyalty service using loyalty-based identifiers, such as phone numbers, email address, name, etc. The location information is correlated to stores proximate to the mobile device and a store that the user is currently located within is identified. If the user then uses the mobile device or a site-based service to perform self-shopping within the store and has initiated a transaction using a realtor-based application (app), the location-based loyalty services processes an Application Programming Interface (API) to alert the retailer's shopping service of the users loyalty-based identifiers. This causes a loyalty account of the user to be injected into the open transaction within the realtor-based app by the retailer's shopping service. If the user initiates the transaction at a transaction terminal within the store rather than using the retailer-based shopping service, a code can be obtained by the user from the terminal that is scanned by the mobile app associated with the location-based loyalty service and provided to the location-based loyalty service. The code identifies the retailer and the terminal. The location-based service uses an API and provides the registered loyalty identifiers for the user to a transaction manager of the retailer. This causes the transaction manager to identify the user's transaction at the terminal, locate the user's loyalty account number, and inject the loyalty account number into the transaction on the terminal during the transaction.

System 100 allows for a contactless (non-touch) and pandemic-friendly technique by which customers of a retailer can achieve frictionless loyalty integration for their transactions with the retailer. The customers do not have to supply cards, provide loyalty identifiers, nor do the customers have to remember their loyalty accounts with the retailers. Customers can shop via retailer-provided apps, checkout at cashier-assisted transaction terminals, or checkout as Self-Service Terminals (SSTs) and loyalty integration into their transactions with the retailers are automatically, transparently, and seamlessly integrated into the transactions on behalf of the customers. Retailers benefit by greater customer adoption and usage of their loyalty programs and customers benefit by not having to remember, manage, and provide loyalty account information during transactions. Moreover, customers benefit by not having to disclose nor enter their loyalty identifiers, which provides improved privacy and security associated with the private details (the loyalty identifiers) of the customers.

As used herein the terms “user,” “customer,” “shopper,” and/or “consumer” may be used interchangeably or synonymously. These terms refer to individuals that engage in transactions and/or checkouts with a retailer.

System 100 comprises a cloud/server 110, a user-operated device 120, a retailer server 130, and a transaction terminal.

Cloud/server 110 comprises a processor 111 and non-transitory computer-readable storage medium 112. Medium 112 comprises executable instructions for a store location manager 113, a location-based loyalty service 114, and a transaction integration manager 115. The executable instructions when executed by processor 111 from medium 112 causes the processor 111 to perform processing discussed herein and below for 113-115.

Each user-operated device 120 comprises a processor 121 and a non-transitory computer-readable storage medium 122. Medium 122 comprises executable instructions for a loyalty integration app 123 and a retailer app 124. The executable instructions when executed by processor 121 from medium 122 cause processor 121 to perform processing discussed herein and below for apps 123 and 124. It is also to be noted that each user-operated device 120 may comprise a variety of integrated peripheral devices, such as a touch display, a camera, a speaker, a microphone, a Global Positioning Satellite (GPS) receiver, etc.

Retailer server 130 comprises a processor 131 and a non-transitory computer-readable storage medium 132. Medium 132 comprises executable instructions for a transaction manager 133, a shopping service 134, and loyalty-based integration API 135. The executable instructions when executed by processor 131 from medium 132 causes the processor 131 to perform processing discussed herein and below for 133-135.

Transaction terminal 140 comprises a processor 141 and a non-transitory computer-readable storage medium 142. Medium 142 comprises executable instructions for a transaction manager 143. The executable instructions when executed by processor 141 from medium 142 cause the processor 141 to perform the processing discussed herein and below for transaction manager 143.

Location-based loyalty service 114 provides features for registering users/customers via a registration interface rendered on integration app 123. Registration information can comprise, a device identifier of device number for user-operated device 120, a user's name, a user's email address, and other information captured from the user during registration. In some cases, the registration information may include specific loyalty account numbers that the user has with various retailers. Integration app 123 may permit any specific loyalty account numbers for specific retailers to be provided via images captured by a camera of user-operated device. In some cases, the user does not have to supply any specific loyalty account number; rather the user-provided device identifier, phone number, name, and email address are sufficient loyalty identifiers that can identify the user's loyalty accounts with the retailers.

Location-based loyalty service 114 maintains a mapping in a data store between a registered user, the user-operated device, and the user's registration information. The mapping is accessed when integration app 123 is initiated on user-operated device 120 to identify the user, device 120, and have access to the corresponding registration information.

Loyalty integration app 123 includes a user-facing interface for interacting with the user and a backend API-based interface for interacting with store location manager 113 and location-based loyalty service 114. When integration app 123 is activated on device 120, the backend interface obtains current location information for device 120 through locations services available on device 120. The location information is reported to store location manager 113 and location-based loyalty service 114 is notified that the user is active and potentially going to or is engaged in a transaction with a retailer.

Store location manager 113 uses the location information reported for device 120 and store location information for stores of retailers and determines when device 120 is present within a given store 120 based on the reported device location information and known location information for the stores.

When store location manager 113 determines that device 120 of the user is within a store of a retailer, store location manager 113 reports a retailer identifier for the retailer and a store identifier for the retailer's store to location-based loyalty service 114.

Location-based loyalty service 114 provides a user identifier for the user, the retailer identifier for the retailer, a device identifier for device 120, the store identifier for the store, and registration or select registration information for the user to transaction integration manager 115. Transaction integration manager 115 provides the device identifier and the registration information or the select registration information to integration API 135 of retailer server 130 associated with the retailer identifier.

Integration API 135 uses the device identifier for device 120 and the provided registration information to identify and to locate a loyalty account for the user that the user previously registered with the retailer. Next, integration API 135 determines if the loyalty account associated with the user is actively engaged in a transaction through retailer app 124 (based on a user identifier maintained with the loyalty account by the retailer—the user identifier for the user may be different from what is associated with the user through location-based loyalty service 114). Determination that the user is actively engaged in a transaction through retailer app 124 may also be achieved by integration API 135 based on a device identifier for device 120 by identifying an active communication session within the store associated with the device identifier. If the user is not actively engaged in a transaction with the retailer via retailer app 124, integration API takes no action on the provided device identifier and the provided registration information.

When the user is actively engaged in a transaction via an active communication session within the store, integration API 135 sends a message comprising the loyalty account number of the user to shopping service 134. Shopping service 134 injects the loyalty account number into the transaction occurring with the user through an active communication session with retailer app 124. This causes the transaction details presented by retailer 100 124 to display the loyalty identification and loyalty account integration on transaction screens presented to the user during the transaction. It is to be noted that at no time did the user have to take any action other than ensuring loyalty-integration app 123 was initiated on device 120. It is also to be noted that the user may have initiated integration app 123 after starting a transaction with retailer app 124 or may have initiated integration app 123 when payment for the transaction was requested by shopping service 134 based on an indication by the user through retailer app 124 that the user was ready to pay for items associated with the transaction.

The loyalty integration was seamless and largely transparent to the user. The only action that the user may have affirmative taken was to initiate or to activate integration app 123 on device 120. However, and in some instances, the user may not have even done this, since the user may have ensured that app 123 always active on device startup or since the user may have initiated app 123 a long time ago or many days prior to the transaction and the user may have forgotten to deactivate app 123 such that app 123 was already active when the user initiated the transaction via retailer app 124.

System 100 also provides another mechanism by which loyalty integration can be achieved during a checkout for a transaction at a transaction terminal 140. In this workflow, the user is not shopping via retailer app 124; rather, the user is either shopping at the store and is checking out at a cashier-assisted Point-Of-Sale (POS) terminal via a cashier or is checkout out at a SST for which the user is performing a self checkout.

Terminal 140 displays or has an affixed label representing a Quick-Response (QR) code or other type of code (such as a number, a string, etc.). The code at least comprises a retailer identifier for the retailer, a store identifier for the store, and a terminal identifier for terminal 140. The code may be provided on a small portion transaction screens rendered during the checkout, rendered on a splash screen of terminal 140 before a transaction is initiated, or printed on a label that is affixed on or proximate to the terminal 140.

The user access integration app 123 and uses an integrated camera of device 120 to capture an image of the code from the display of terminal 110 or to capture an image of the code from a label that is affixed on a surface or that is affixed on an adjacent surface (adjacent to a surface of terminal 140). Integration app 123 provides the code to location-based loyalty service 114 and location-based loyalty service 114 obtains the user's registration information and provides the retailer identifier, store identifier, terminal identifier, and select user registration information to transaction integration manager 115.

Transaction integration manager 115 provides the user registration information, the store identifier for the store, and the terminal identifier for terminal 140 to integration API 135. Integration API 135 locates the loyalty account of the user from the loyalty data store of the retailer using the provided registration information. Next, the loyalty account number for the loyalty account of the user and the transaction terminal identifier for terminal 140 is provided to transaction manager 133. Transaction manager 133 locates the current transaction associated with the user based on the terminal identifier for the terminal and sends the loyalty account number to transaction manager 143 of terminal 140. Transaction manager 143 injects the loyalty account for the user into the transaction details for the transaction and presents the loyalty identification of the user and the loyalty based prices for items being purchased by the user on transaction screens being rendered during the transaction for viewing by the user.

Again, this entire loyalty integration and injection into the transaction at terminal 140 is achieved seamlessly and frictionless from the perspective of the user. The user only accessed integration app 123 to capture a single image of a code and this caused loyalty account information to be dynamically and in real time integrated into the transaction on behalf of the user. The user did not have to enter any loyalty identifiers and did not have to swipe or provide any loyalty card. Moreover, the user can be engaged in a self-checkout via an SST 110 or can be engaged in an assisted checkout via a POS 110. When the user was engaged in an assisted checkout, no communication between the user and the cashier is needed for the loyalty integration and no action is required at all by the cashier for the loyalty integration. In fact, any cashier may be completely unaware of the loyalty integration during the transaction (unless of course the cashier views the transaction details and sees the loyalty account integration).

FIG. 1B is a diagram for identifying a store that a consumer is present within using location-based services, according to an example embodiment.

Site service as illustrated in FIG. 1B corresponds to store location manager 113, location-based loyalty service 114, and transaction integration manager 115. Site as illustrated in FIG. 1B corresponds to transaction manager 133, shopping service 134, and integration API 135.

User-operated device 120 reports location information via app 123 to store location manager 113 and location-based loyalty service 114 receives the store and retailer identifiers for the user (user-operated device 120) from store location manager 113. Location-based loyalty service 114 obtains the users registration information (can be loyalty identifiers or a specific loyalty account that the user registered for the retailer) and provides a device identifier for device 120, store identifier, retailer identifier, and registration information to transaction integration manager 115. Transaction integration manager 115 locates the appropriate retailer server 130 from the store identifier and retailer identifier and provides the corresponding integration API 135 the device identifier for device 120 and the registration information for the user. Integration API 135 obtains the users loyalty account and corresponding loyalty account identifier and interacts with shopping service 134 to identify any transaction in progress with the user via retailer app 124. Shopping service 134 then injects the loyalty account number into the transaction automatically without any action being required of the user.

FIG. 1C is a diagram depicting an identification of a loyalty account of the consumer, according to an example embodiment.

Consumer data management corresponds to the data management and loyalty mapping features of location-based loyalty service 114.

FIG. 1C illustrates an embodiment, where the registration information provided by the user during registration with location-based loyalty service allows the user to provide specific loyalty account numbers for specific retailers, such that when the user logs into the location-based loyalty service 114, location-based loyalty service 114 has a mapping between an account of the user to specific loyalty accounts that the user has with specific retailers.

As noted above, in other embodiments the user does not have to provide such specificity and can provide loyalty identifiers, which integration API 135 can use to location a specific loyalty account of the user with a given retailer.

FIG. 1D is a diagram depicting an identification of a specific transaction being performed by or on behalf of the consumer where the loyalty account of the consumer is injected into the transaction workflow, according to an example embodiment.

Site, order service, and selling service correspond to transaction manager 133, shopping service 134, and integration API 135 for a specific retailer or a specific store of a given retailer.

Integration API 135 receives the device identifier for device 120 and the registration information (which may include a specific loyalty account of the user or which may not (as discussed above)) from transaction integration manager 115. Integration API 135 then interacts with transaction manager 113 and/or shopping service 134 to identify an open transaction or ongoing transaction associated with the user within the store (which may be at a terminal 140 or which may be progressing via retailer app 124). Integration API 135 also uses the received registration information to identify the user's loyalty account with the retailer. The loyalty account number is then integrated into the transaction in a manner that is frictionless from the perspective of the user (as discussed above).

FIG. 1E is a diagram depicting an identification of a specific transaction terminal of an in-progress transaction being performed by or on behalf of the consumer with the loyalty account of the user injected into the in-progress transaction workflow at the terminal, according to an example embodiment.

A QR code that is encoded with a retailer identifier, a store identifier, and a terminal identifier for terminal 140 is rendered on transaction screens or a splash screen of a transaction display of terminal 140. The user activates app 123 and uses an integrated camera of device 120 to capture an image of the code within the app 123. App 123 decodes the code and sends the decoded code to location-based loyalty service 114. The user's registration information is obtained; the decoded retailer identifier, store identifier, and terminal identifier are provided to transaction integration manager 115. Transaction integration manager 115 contacts the appropriate integration API 135 and provides the store identifier, terminal identifier, and user registration information. Integration API 135 locates (if not provided with the registration information) the user's loyalty account with the retailer and provides the loyalty account number and terminal identifier to transaction manager 133. Transaction manager 133 injects the loyalty account number into the transaction (transaction workflow) with transaction manager 143 of terminal 140. The user's transaction at terminal 140 is updated to reflect integration of the user's loyalty account seamlessly and in a frictionless manner (the user or cashier operating terminal 140) did not have to perform any action or touching of any component of terminal 140.

FIG. 1F is a diagram depicting integration of the consumer's loyalty account into the transaction workflow of the transaction terminal in order to dynamically modify transaction prices for items based on the consumer's loyalty account, according to an example embodiment.

FIG. 1F illustrated an updated transaction workflow for a transaction being processed on terminal 140 that shows the loyalty account of the user integrated into a transaction screen of the display associated with terminal 140. The transaction workflow is dynamically and in real time updated to reflect entry of the user's loyalty account number. This is achieved without any touching of or physical interaction with terminal 140 to provide the loyalty card of loyalty identifiers of the user. Again, terminal 140 may be operated by the user for an SST or may be a POS terminal operated by a cashier performing an assisted checkout on behalf of the user.

In an embodiment, when the location-based loyalty service 114 is unable to locate a loyalty account number for a user with the existing registered loyalty identifiers, service 114 prompts the user through loyalty integration app 123 to snap a picture of the user's loyalty card with the retailer, to enter the loyalty account, and/or to provide different loyalty identifiers (identifiers which were not originally registered by the user with service 114). In this way, the user is notified that the loyalty for the transaction was unable to be resolved and the user is provided an opportunity to rectify with the loyalty account number or with additional previously unregistered loyalty identifiers (which may be processed further by service 114 to locate the user's loyalty account). In this embodiment, the user is interacted with to resolve the loyalty account number for a given transaction but the user still does not have to manually touch or provide any loyalty details for input on terminal 140 or to a cashier operating terminal 140 during the transaction.

In an embodiment, integration API 135 resides on cloud/server 110. In this embodiment, a different API that resides on retailer server 130 permits interaction by integration API 135 with a loyalty data store of a given retailer and transaction workflows for transactions being processed by transaction manager 133 in conjunction with transaction manager 143 and for transaction be processed by shopping service 134 in conjunction with retailer app 124.

In an embodiment, a given retailer may permit all transaction workflows to be processed by cloud/server 110, such that cloud server 110 comprises transaction manager 133, shopping service 134, and integration API 135.

In an embodiment, user-operated device 120 is a phone, a tablet, a desktop, a laptop, or a wearable processing device (e.g., smart glasses, watch, etc.).

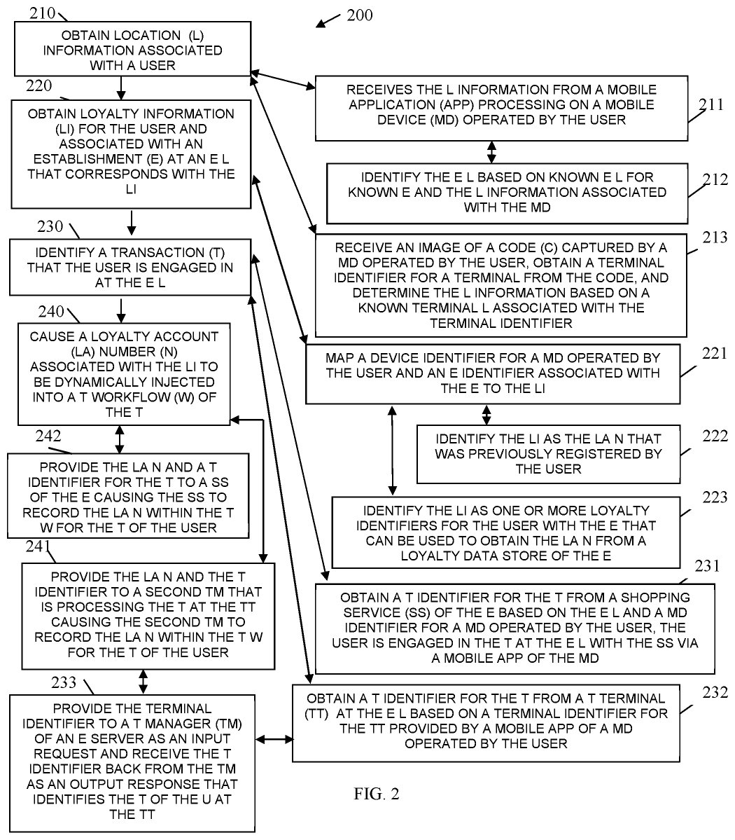

The above-noted embodiments and other embodiments are now discussed with FIG. 2.

FIG. 2 is a diagram of a method 200 for providing location-based loyalty services, according to an example embodiment. The software module(s) that implements the method 200 is referred to as a “location-based loyalty service.” The location-based loyalty service is implemented as executable instructions programmed and residing within memory and/or a non-transitory computer-readable (processor-readable) storage medium and executed by one or more processors of one or more devices. The processor(s) of the device(s) that executes the location-based loyalty service are specifically configured and programmed to process the location-based loyalty service. The location-based loyalty service may have access to one or more network connections during its processing. The network connections can be wired, wireless, or a combination of wired and wireless.

In an embodiment, the location-based loyalty service executes on cloud 110. The cloud 110 comprises one or more servers that are logically assembled and cooperate as a single server.

In an embodiment, the location-based loyalty service executes on a server 130.

In an embodiment, location-based loyalty service executes on a combination of devices associated with cloud 110 and server 130.

In an embodiment, the AR event integrator is all of or some combination of 113-115 and 133-135.

At 210, the location-based loyalty service obtains location information associated with a user.

In an embodiment, at 211, the location-based loyalty service receives the location information from a mobile application 123 processing on a mobile device 120 operated by the user.

In an embodiment of 211 and at 212, the location-based loyalty service identifies an establishment location for an establishment based on known establishment locations for known establishments and the location information associated with the mobile device 120.

In an embodiment, at 213, the location-based loyalty service receives an image of a code captured by a mobile device 120 operated by the user, obtains a terminal identifier for a terminal 140 from the code, and determines the location information based on a known terminal location associated with the terminal identifier. In an embodiment, the code is an a QR code.

At 220, the location-based loyalty service obtains loyalty information for the user and associated with an establishment location for the establishment. The establishment location corresponds or correlates to the location information for the user.

In an embodiment, at 221, the location-based loyalty service maps a device identifier for a mobile device 120 operated by the user and an establishment identifier associated with the establishment to the location information.

In an embodiment of 221 and at 222, the location-based loyalty service identifies the loyalty information as a loyalty account number that was previously registered by the user for the establishment with the location-based loyalty service.

In an embodiment of 221 and at 222, the location-based loyalty service identifies the loyalty information as one or more loyalty identifiers for the user with the establishment. The loyalty identifiers can be used to search for and obtaining the loyalty account number for a loyalty data store of the establishment.

At 230, the location-based loyalty service identifies a transaction (an in-progress transaction) that the user is engaged in at the establishment location.

In an embodiment, at 231, the location-based loyalty service obtains a transaction identifier for the transaction from a transaction service 134 or shopping service 134 of the establishment based on the establishment location and a mobile device identifier for a mobile device 120 operated by the user. The user is engaged in the transaction (in-progress transaction) at the establishment location with the shopping service 134 via a mobile app (retailer app 124) of the mobile device 120.

In an embodiment, at 232, the location-based loyalty service obtains a transaction identifier for the transaction (in-progress transaction) based on a terminal identifier for a transaction terminal 140. The terminal identifier provided in an image of a code that is provided by a mobile app 123 (loyalty integration app) of a mobile device 120 operated by the user.

In an embodiment of 232 and at 233, the location-based loyalty service provides the terminal identifier to a transaction manager 133 of an establishment server 130 as an input request and the location-based loyalty service receives the transaction identifier back from the transaction manager 133 as an output response that identifies the transaction of the user at the transaction terminal 140.

At 240, the location-based loyalty service causes a loyalty account number associated with the loyalty information to be dynamically injected into a transaction workflow of the transaction. That is, the in-progress transaction's workflow receives the loyalty account number via an API and associates the in-progress transaction with the loyalty account of the user with the establishment. This automatically causes the workflow to modify transaction prices for items of the transaction based on loyalty prices provided to loyalty members and associates the transaction price total with credits in the loyalty system of the establishment. This is also done without any loyalty data having to be entered by the user or a cashier to locate the loyalty account (no loyalty card is provided by the user nor is any loyalty identifiers or account number required of the user for the in-progress transaction).

In an embodiment of 233 and 240, at 241, the location-based loyalty service provides the loyalty account number and the transaction identifier to a second transaction manager 143 that is processing the transaction at the transaction terminal 140 causing the second transaction manager 143 to record the loyalty account number within the transaction workflow for the transaction of the user.

In an embodiment, at 242, the location-based loyalty service provides the loyalty account number and a transaction identifier for the transaction to a transaction service 134 or a shopping service 134 of the establishment causing the shopping service 134 to record the loyalty account number within the transaction workflow for the transaction of the user.

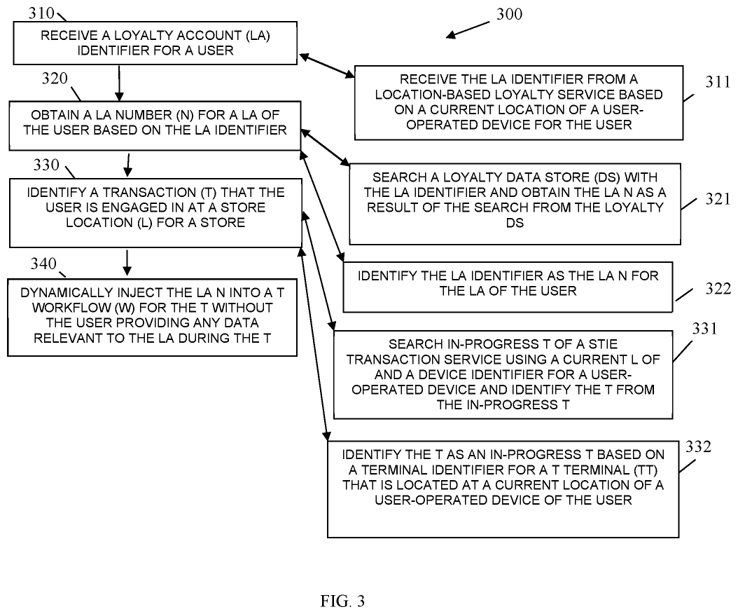

FIG. 3 is a diagram of a method 300 for providing location-based loyalty services, according to an example embodiment. The software module(s) that implements the method 300 is referred to as a “loyalty account injection service.” The loyalty account injection service is implemented as executable instructions programmed and residing within memory and/or a non-transitory computer-readable (processor-readable) storage medium and executed by one or more processors of one or more devices. The processor(s) of the device(s) that executes the loyalty account injection service are specifically configured and programmed to process the loyalty account injection service. The loyalty account injection service may have access to one or more network connections during its processing. The network connections can be wired, wireless, or a combination of wired and wireless.

In an embodiment, the loyalty account injection service executes on server 130.

In an embodiment, the loyalty account injection service is all of, or some combination of 133-135.

The loyalty account injection service interacts with method 200 to perform loyalty account integration within a transaction workflow for a transaction that a user is engaged in with a retailer at a retailer store.

At 310, the loyalty account injection service receives a loyalty account identifier for a user.

In an embodiment, at 311, the loyalty account injection service receives the loyalty account identifier from a location-based loyalty service (114 and 115) based on a current location of a user-operated device 120 for the user.

At 320, the loyalty account injection service obtains the loyalty account number for a loyalty account of the user based on the loyalty account identifier.

In an embodiment, at 321, the loyalty account injection service searches a loyalty data store with the loyalty account identifier and obtains a loyalty account number as a result of the search from the loyalty data store.

In an embodiment, at 322, the loyalty account injection service identifies the loyalty account identifier as the loyalty account number for the loyalty account of the user.

At 330, the loyalty account injection service identifies an in-progress transaction that the user is currently engaged in (performing) at a store location for a store.

In an embodiment, at 331, the loyalty account injection service searches in-progress transaction of a site transaction service 134 using a current location of and a device identifier for a user-operated device 120 and the loyalty account injection service identifies the in-progress transaction from the in-progress transactions.

In an embodiment, at 332, the loyalty account injection service identifies the in-progress transaction as the in-progress transaction based on a terminal identifier for a transaction terminal 140 that is located at a current location of a user-operated device 120 of the user.

At 340, the loyalty account injection service dynamically injects the loyalty account number into a transaction workflow for the in-progress transaction without the user (or a cashier) having provided any inputted (entered) data relevant to the loyalty account during the transaction.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining location information associated with a user;
obtaining loyalty information for the user and associated with an establishment at an establishment location that corresponds with the location information;
identifying a transaction that the user is engaged in at the establishment location; and
causing a loyalty account number associated with the loyalty information to be dynamically injected into a transaction workflow of the transaction.

2. The method of claim 1, wherein obtaining the location information further includes receiving the location information from a mobile application processing on a mobile device operated by the user.

3. The method of claim 2, wherein receiving further includes identifying the establishment location based on known establishment locations for known establishments and the location information associated with the mobile device.

4. The method of claim 1, wherein obtaining the location information further includes receiving an image of a code captured by a mobile device operated by the user, obtaining a terminal identifier for a terminal from the code, and determining the location information based on a known terminal location associated with the terminal identifier.

5. The method of claim 1, wherein obtaining the loyalty information further includes mapping a device identifier for a mobile device operated by the user and an establishment identifier associated with the establishment to the loyalty information.

6. The method of claim 5, wherein mapping further includes identifying the loyalty information as the loyalty account number that was previously registered by the user.

7. The method of claim 5, wherein mapping further includes identifying the loyalty information as one or more loyalty identifiers for the user with the establishment that can be used to obtain the loyalty account number from a loyalty data store of the establishment.

8. The method of claim 1, wherein identifying further includes obtaining a transaction identifier for the transaction from a shopping service of the establishment based on the establishment location and a mobile device identifier for a mobile device operated by the user, wherein the user is engaged in the transaction at the establishment location with the shopping service via a mobile application of the mobile device.

9. The method of claim 1, wherein identifying further includes obtaining a transaction identifier for the transaction from a transaction terminal at the establishment location based on a terminal identifier for the transaction terminal provided by a mobile application of a mobile device operated by the user.

10. The method of claim 9, wherein obtaining the transaction identifier further includes providing the terminal identifier to a transaction manager of an establishment server as an input request and receiving the transaction identifier back from the transaction manager as an output response that identifies the transaction of the user at the transaction terminal.

11. The method of claim 10, wherein causing further includes providing the loyalty account number and the transaction identifier to a second transaction manager that is processing the transaction at the transaction terminal causing the second transaction manager to record the loyalty account number within the transaction workflow for the transaction of the user.

12. The method of claim 1, wherein causing further includes providing the loyalty account number and a transaction identifier for the transaction to a shopping service of the establishment causing the shopping service to record the loyalty account number within the transaction workflow for the transaction of the user.

13. A method, comprising:
receiving a loyalty account identifier for a user;
obtaining a loyalty account number for a loyalty account of the user based on the loyalty account identifier;
identifying a transaction that the user is engaged in at a store location for a store; and
dynamically injecting the loyalty account number into a transaction workflow for the transaction without the user providing any data relevant to the loyalty account during the transaction.

14. The method of claim 13, wherein receiving further includes receiving the loyalty account identifier from a location-based loyalty service based on a current location of a user operated device for the user.

15. The method of claim 13, wherein obtaining further includes searching a loyalty data store with the loyalty account identifier and obtaining the loyalty account number as a result of the searching from the loyalty data store.

16. The method of claim 13, wherein obtaining further includes identifying the loyalty account identifier as the loyalty account number for the loyalty account of the user.

17. The method of claim 13, wherein identifying further includes searching in-progress transactions of a site transaction service using a currently location of and a device identifier for a user-operated device and identifying the transaction from the in-progress transactions.

18. The method of claim 13, wherein identifying further includes identifying the transaction as an in-progress transaction based on a terminal identifier for a transaction terminal that is located at a current location of a user-operated device of the user.

19. A system comprising:
a cloud processing environment comprising at least one server;
the at least one server comprising at least one processor and a non-transitory computer-readable storage medium;
the non-transitory computer-readable storage medium comprising executable instructions; and
the executable instructions when executed by the at least one processor from the non-transitory computer-readable storage medium cause the at least one processor to perform operations comprising:
determining a current location of a user based on either a device location reported from a user-operated device or a terminal identifier for a transaction terminal provided in an image for a code captured and provided by the user-operated device;
identifying a retailer and a store of the retailer based on the current location;
obtaining at least one loyalty identifier for a loyalty account of the user with the retailer based on the retailer;
identifying a loyalty account number for the loyalty account based on the at least one loyalty identifier;
determining an in-progress transaction of the user with the store based on the current location, the retailer, and the store and further based on a device identifier for the user-operated device or the terminal identifier for the transaction terminal; and
causing the loyalty account number to be injected into a transaction workflow or the in-progress transaction without the user or a cashier associated with the transaction terminal entering any data during the in-progress transaction that is relevant to the loyalty account of the user.

20. The system of claim 19, wherein the transaction terminal is a Self-Service Terminal (SST) or a Point-Of-Sale (POS) terminal, and wherein the user-operated device is a phone, a tablet, a laptop, or a wearable processing device.
